(19) United States
(12) Patent Application Publication
(10) Pub. No.: US 2025/0375980 A1
(43) Pub. Date: Dec. 11, 2025

(54) WHEEL HUB AND WHEEL HEAD OF A MOTOR VEHICLE

(71) Applicant: ZF Friedrichshafen AG, Friedrichshafen (DE)

(72) Inventors: Martin Lang, Wegscheid (DE); Thomas Waim, Grafenau (DE)

(73) Assignee: ZF Friedrichshafen AG, Friedrichshafen (DE)

(21) Appl. No.: 19/230,415

(22) Filed: Jun. 6, 2025

(30) Foreign Application Priority Data
Jun. 7, 2024 (DE) 10 2024 205 275.2

(51) Int. Cl. B60B 27/00; B60B 27/02; B60L 50/60

(52) U.S. Cl. CPC B60B 27/0021; B60B 27/0052; B60B 27/0068; B60B 27/02; B60L 50/60

(57) ABSTRACT

A wheel hub (100) for a wheel head of a motor vehicle has a hub base body (10) extending axially to an axis of rotation (2) and a wheel flange (20) arranged on the hub base body (10). The wheel flange (20) extends radially to the axis of rotation (2). The hub base body (10) has a press fit contour (12) for forming a press fit connection with a sensor plate (30) for a speed sensor (40), where the press fit contour (12) has at least one contour interruption (14). A wheel head is provided for an axle of a motor vehicle having a wheel hub (100), where a sensor plate (30) has a detection ring extending conically with respect to an axis of rotation (2) of the wheel hub (100), and where a detection region (42) of a speed sensor (40) is aligned with the conical detection ring.

### TECHNICAL FIELD

The present invention relates to a wheel hub for a wheel head of a motor vehicle. The present invention also relates to a wheel head for an axle of a motor vehicle. The present invention also relates to an axle of a motor vehicle with such a wheel head and to a motor vehicle with such an axle.

### PRIOR ART

The prior art discloses sensor arrangements in a wheel head of a motor vehicle, which have a sensor ring as a transmitter element for detecting a wheel speed by means of a sensor. U.S. Pat. No. 5,893,648 A disclose s a sensor of such a sensor arrangement pressed onto a vehicle axle and the sensor element arranged on a hub seal ring of the hub of the wheel head. It is also known from EP 0507340 A1 that the sensor element is pressed onto the hub of the wheel head and that a sensor is arranged radially offset from the sensor element.

### PRESENTATION OF THE INVENTION

One task of the present invention is to improve the arrangement and fastening of a sensor plate for a speed sensor on a wheel hub. This task is solved by the subject matter of the independent claims.

One aspect relates to a wheel hub for a wheel head of a motor vehicle. The wheel hub can be rotatably mounted on a hub carrier of the wheel head. The wheel hub can be driven by a drive shaft of the wheel head. The wheel hub may therefore be an electrically driven wheel hub.

The wheel hub has a hub base body which extends axially to an axis of rotation of the wheel hub. The hub base body may have a wheel bearing for rotatably mounting the wheel hub on the hub carrier. The hub base body may also have a cylindrical base shape extending axially to the axis of rotation.

The wheel hub has a wheel flange which is arranged on the hub base body. The wheel flange extends radially from the axis of rotation. The wheel flange can be arranged on the hub base body and extend radially outward therefrom. The wheel flange may have mountings for wheel bolts or wheel screws for fastening a wheel rim to the wheel hub.

The hub base body has a press fit contour for forming a press fit connection between a sensor plate for a speed sensor and the hub base body. The press fit contour can be formed by a geometric shape of the hub base body, which is formed by one or more surface region on the outside or inside of the hub base body. The press fit contour may be an outer press fit contour for forming a press fit connection between an inner press fit contour of the sensor plate and the outer press fit contour. The outer press fit contour can be formed by one or more surface regions on the outside of the hub base body.

The press fit connection can be a shaft-hub connection or a press connection designed as a cylindrical press fit, for example a press fit connection designed as a longitudinal press fit connection. The press fit connection can be made by press-fitting the hub body and the sensor plate onto the press fit contour. This allows a press fit connection of the sensor plate and the hub base body to be created at the press fit contour.

The press fit contour has at least one contour interruption. The press fit contour may therefore be an interrupted press fit contour. The press fit contour can thus be interrupted at least one potential connection point with the sensor plate. The press fit connection of the sensor plate to the hub base body can therefore be formed on spaced-apart contour regions of the press fit contour, wherein the contour regions can be separated from one another by the at least one contour interruption. The contour regions can be spaced apart from each other by at least one contour interruption. The contour regions can form separate or interrupted fitting seats for the press fit connection. The press fit contour can therefore extend in sections distributed over 360 degrees of the circumference of the press fit contour as an interrupted fitting circumference on the hub base body.

The wheel hub thus provides an advantageous means of producing a press fit between the sensor plate and the interrupted press fit contour on the hub base body in an axially compact design, wherein the press fit with the interrupted press fit contour is less susceptible to tolerances than an uninterrupted press fit contour on the hub base body. Requirements for the axial dimensions and manufacturing tolerances for a press fit to be produced between the sensor plate and the hub base body, as well as between the hub base body or the sensor plate itself as components to be manufactured, can thus be reduced.

Another advantage of the interrupted press fit contour and the resulting sectional press fit connection can be increased flexibility in the press assembly of the sensor plate and the hub base body produced with the press fit connection. With the interrupted press fit contour and the resulting increased flexibility, the force required to assemble or disassemble the sensor plate for press fitting to the hub base body can be reduced compared to the uninterrupted press fit contour on the hub base body. This can have a further positive effect on reducing tolerance susceptibility, as a higher overlap of the components can be achieved with a specified maximum force for mounting or removing the sensor plate during press fitting.

According to one embodiment of the wheel hub, the press fit contour can be formed radially around an axial end region of the hub base body. The press fit contour can be formed on one end face or end surface of the hub base body. According to this embodiment, the at least one contour interruption may have a recess that is open on one side. The hub base body can thus have at least one recess open on one side at the axial end region. The hub base body may also have at least one recess he axial end region, which forms the at least one recess that is open on one side. The contour interruption or the recess open on one side can be cast or machined, for example milled. The Interrupted pass fit contour can thus be produced in a particularly efficient manner.

According to a further embodiment of the wheel hub, the press fit contour can be formed on a radially outer region of the hub base body. The hub base body may have a rebate on which the press fit contour is formed, with the rebate running radially around the outside of the hub base body. The rebate can be formed at the axial end region of the hub base body, wherein the rebate can form the end face of the hub base body. The rebate may have an L-shaped cross-section, wherein the press fit connection of the sensor plate may be formed with the axially extending rebate surfaces of the rebate that radially surround the hub base body. The radially circumferential rebate surfaces can form the interrupted press fit contour. The press fit contour may also have an axial stop for the sensor plate on the radially extending rebate surfaces of the rebate that radially surround the hub base body.

According to a further embodiment of the wheel hub, the press fit contour may have at least two contour interruptions which are formed on the press fit contour with a uniform rotational angle offset relative to the axis of rotation. The press fit contour may have at least two surface regions which form the press fit contour. The contour interruptions can be arranged rotationally symmetrical with respect to the axis of rotation. The surface regions can also be arranged rotationally symmetrical with respect to the axis of rotation. The redundant contour interruptions mean that the press fit is particularly resistant to tolerances, as manufacturing tolerances can be compensated for in an advantageous manner by the multiple and symmetrically interrupted hub base body.

According to a further embodiment of the wheel hub, the at least one contour interruption may extend axially to the axis of rotation and beyond the press fit contour into the hub base body. The contour interruption can include a recessed region that extends axially beyond the press fit contour. If the hub base body has a rebate on which the press fit contour can be formed, the contour interruption can extend axially to the axis of rotation and beyond the rebate into the hub base body. According to this further embodiment, when the sensor plate is pressed against the press fit contour, an opening may be formed in the hub base body at the contour interruption. The contour interruption can only be partially covered by the sensor plate when it is pressed against the press fit contour. wherein the opening in the hub base body at the contour interruption is not covered by the sensor plate. In addition to the manufacturing advantages described above, the contour interruption with the opening can therefore also provide advantageous dirt and water drainage from a free space between the hub base body and the hub carrier. Furthermore, the opening can be provided in a particularly advantageous manner for maintenance of a wheel head, for example for a tool holder for removing the sensor plate from the hub base body using a hook-shaped removal tool, for example when replacing a wheel bearing.

Another aspect relates to a wheel head for an axle of a motor vehicle. The wheel head may be an electrically driven wheel head. The axle may be an electrically driven axle. The axle can have two wheel heads, each of which can have an electric single-wheel drive.

The wheel head has a hub carrier. The hub carrier may be a stationary component of the wheel head relative to a rotating wheel. The wheel head has a wheel hub which is mounted on the hub carrier so that it can rotate about an axis of rotation. The wheel head may have a wheel bearing through which the wheel hub is rotatably mounted on the hub carrier. The wheel hub has a hub base body which extends axially to the axis of rotation. The hub base body can be arranged on the wheel bearing. The wheel hub has a wheel flange which is arranged on the hub base body. According to one embodiment of the wheel head, the wheel hub may be designed in accordance with the preceding aspect. According to this embodiment, the sensor plate can be pressed onto the press fit contour, which has at least one contour interruption. At least one of the hub base body and the wheel flange may also be designed as described in the previous aspect.

The wheel head has a sensor plate pressed onto the hub base body. The sensor plate can be designed as described in the previous aspect. The sensor plate can be pressed onto the hub base body in the state pressed against the press fit contour. The wheel head has a speed sensor which is arranged on the hub carrier and is designed to detect rotation of the sensor plate relative to the hub carrier. The speed sensor may be an ABS sensor. The ABS sensor can be set up to detect or pick up an ABS signal on the sensor plate. If the speed sensor is an ABS sensor, the sensor plate may be an ABS sensor plate. The sensor plate can form a sensor element for detecting a wheel speed by means of the speed sensor. The speed sensor can be a passive sensor, such as an inductive sensor, for detecting the wheel speed. If the speed sensor is a passive sensor, the sensor plate may have ring-shaped, repetitive slit-like recesses or a gear ring, which generate a variable magnetic field and a voltage that changes in the passive sensor. The speed can be measured at the recesses or teeth of the gear ring. The sensor plate can therefore form a sensor disc for or a pulse disc for the speed sensor. The speed sensor may also be an active sensor, such as a magnetic sensor, for detecting the wheel speed. If the speed sensor is an active sensor, the sensor plate itself can generate a magnetic field that can be detected by the active sensor.

The sensor plate has a detection ring that extends conically with respect to the axis of rotation. The sensor plate can therefore extend at an angle to the axis of rotation and thus be funnel-shaped. The sensor plate can extend axially in relation to the axis of rotation. An axial extension or length of the sensor plate can be based on the conicity of the detection ring. The detection ring can therefore extend at an angle to the axis of rotation. The detection ring can be either a passive or active detection ring. If the speed sensor is a passive sensor, the detection ring can feature the ring-shaped, repeating recesses or the gear ring. If the speed sensor is an active sensor, the detection ring may have a magnetic ring that generates the magnetic field that can be detected by the active sensor. One detection region of the speed sensor is aligned with the conical detection ring.

With the axially pressed-on, conical detection ring and the speed sensor aligned with it. the wheel head can be used to advantageously reduce the axial installation space in the wheel head occupied by the sensor plate and the speed sensor. This frees up axial installation space for additional components or compensates for the axial installation space required for additional components while maintaining the axial dimensions of the wheel head. This is particularly advantageous for reducing the axial dimensions of an electrically driven wheel head in which the electrical drive c ponents of the wheel head require additional axial installation space.

According to one embodiment of the wheel head, a longitudinal axis of a sensor housing of the speed sensor may extend obliquely to the axis of rotation. The longitudinal axis of the sensor housing can correspond to a detection direction of the detection region of the speed sensor. The longitudinal axis may also correspond to a main direction of extension of the speed sensor. With a speed sensor arranged at an angle to the axis of rotation in this way, the axial installation space in the wheel head occupied by the sensor plate and the speed sensor can be further reduced in an advantageous manner.

According to a further embodiment of the wheel head, the sensor plate may have a press ring that is continuous in the radial circumferential direction and is pressed onto the hub base body. The uninterrupted press ring can extend continuously over 360 degrees of the circumference of the sensor plate. The uninterrupted press ring can form the press fit connection with the press fit contour. The uninterrupted press ring can have a chamfer, for example an L-bend. The chamfer may form a radially outward collar on the sensor plate. If the hub base body has a rebate on which the press fit contour can be formed, the chamfer can strike against the axial stop of the rebate. The press fit connection can thus be advantageously positioned precisely on the hub base body, whereby the speed sensor can be kept constantly aligned with the sensor plate during operation of the wheel head.

According to a further embodiment of the wheel head, the sensor plate can be pressed onto an axial end region of the hub base body, which faces a drive side of the wheel head. According to this further embodiment, a drive device for driving a drive shaft of the wheel head can be arranged on the drive side. The drive side may have a drive device for rotating the drive shaft. The drive device may comprise at least one of an engine component, for example a rotor or a stator, or a gear wheel for driving the drive shaft. If the sensor plate is pressed onto the axial end region of the hub base body facing the drive side of the wheel head, the conical sensor plate and the speed sensor aligned and arranged at an angle to the conical sensor plate on the drive side provide axial installation space for the drive device. If the drive device is arranged in the axial installation space provided, the axial dimension of the wheel head can be reduced on the drive side in a particularly advantageous manner.

According to a further embodiment of the wheel head, the hub base body may have a support section for supporting the drive device, which extends radially to the axis of rotation. The support section can extend radially beyond the sensor plate in relation to the axis of rotation. A gear wheel or an engine component may be attached or arranged on the drive shaft, wherein the gear wheel or the engine component is designed to drive the drive shaft. The gear wheel or engine component can be rotatably mounted on the support section. The gear wheel or engine component can be arranged at least partially radially overlapping with the speed sensor in the wheel head. The speed sensor can be positioned radially outside the gear wheel or engine component in relation to the axis of rotation. The conical sensor plate and the speed sensor, which is aligned and arranged at an angle to the conical sensor plate, enable the gear wheel or engine component in an axially compressed arrangement according to this embodiment to further reduce the axial dimension of the wheel head on the drive side.

According to a further embodiment of the wheel head, the wheel head may comprise a wheel hub gear for coupling the drive shaft to the wheel hub. The wheel hub gear can be arranged adjacent to the further axial end region of the hub base body, which is formed opposite the axial end region of the hub base body onto which the sensor plate is pressed, and can be formed on a gear side of the wheel head. The sensor plate and the speed sensor can thus be arranged on the drive side, which is opposite the gear side of the wheel head. The wheel hub gear may have a planetary gear set which couples the drive shaft to the wheel hub, wherein a planetary carrier of the planetary gear set may be rotatably coupled to the wheel hub. The wheel head can thus be designed in a particularly axially compact manner.

According to a further embodiment of the wheel head, the latter may have a brake disc which is fastened to the wheel flange. The brake disc may have a circumferential radial offset, which forms an annular gap between the brake disc and the hub carrier and in which the speed sensor may be at least partially arranged. The brake slide can be arranged on the drive side of the wheel head, wherein a brake caliper can be attached to the support section. The brake disc may have a braking surface that has the circumferential radial offset. The annular gap can be formed on the braking surface. The speed sensor can thus be arranged so that it protrudes into the annular gap of the brake disc. The brake slide can be arranged at least partially radially overlapping with the speed sensor in the annular gap. The speed sensor can be positioned radially within the brake disc or the braking surface in relation o the axis of rotation. Due to the intrusive arrangement of the speed sensor in the brake slide, the axial dimension of the wheel head on the drive side can be further reduced in accordance e with this embodiment.

Another aspect relates to an axle of a motor vehicle which has a wheel head in accordance with the preceding aspect. The axle may be a commercial vehicle axle. The axle can be designed as described for other aspects. Another aspect relates to a motor vehicle that has an axle as described above.

According to one embodiment, the motor vehicle can be designed as a commercial vehicle. The motor vehicle may have an energy source for electrically driving the axle. The energy source can be a battery or a fuel cell. The commercial vehicle can be any vehicle used to transport people or goods, such as a bus or a truck.

Corresponding embodiments of at least one of the further aspects may be embodiments of aspects and features described in one aspect.

### BRIEF DESCRIPTION OF THE FIGURES

FIG. 1 shows a motor vehicle with an axle and a wheel head according to respective embodiments in a schematic representation.

FIG. 2 shows the wheel head from FIG. 1 with a wheel hub according to one embodiment in a sectional view.

FIG. 3 shows a press fit connection between a sensor plate and a press fit contour of the wheel hub from FIG. 2 and a speed sensor in a sectional view.

FIG. 4 shows the wheel hub from FIG. 2 in a perspective view.

FIG. 5 shows the sensor plate from FIG. 3 in a perspective sectional view.

### DETAILED DESCRIPTION OF EMBODIMENTS

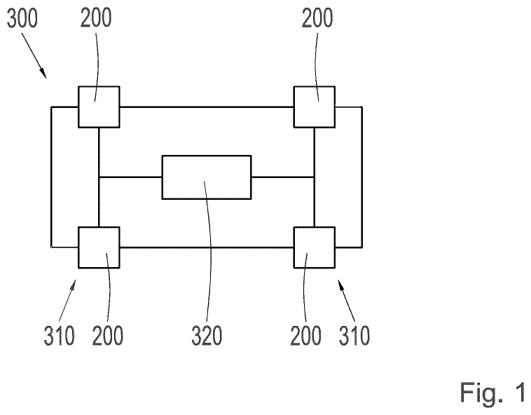

FIG. 1 shows a motor vehicle 300 with two electrically driven axles 310. Each axle 310 has two wheel heads 200. The wheel heads 200 each feature an electric single-wheel drive. The motor vehicle 300 also has an energy source 320 for electrically driving the axles 310. The motor vehicle 300 is a commercial vehicle in one embodiment.

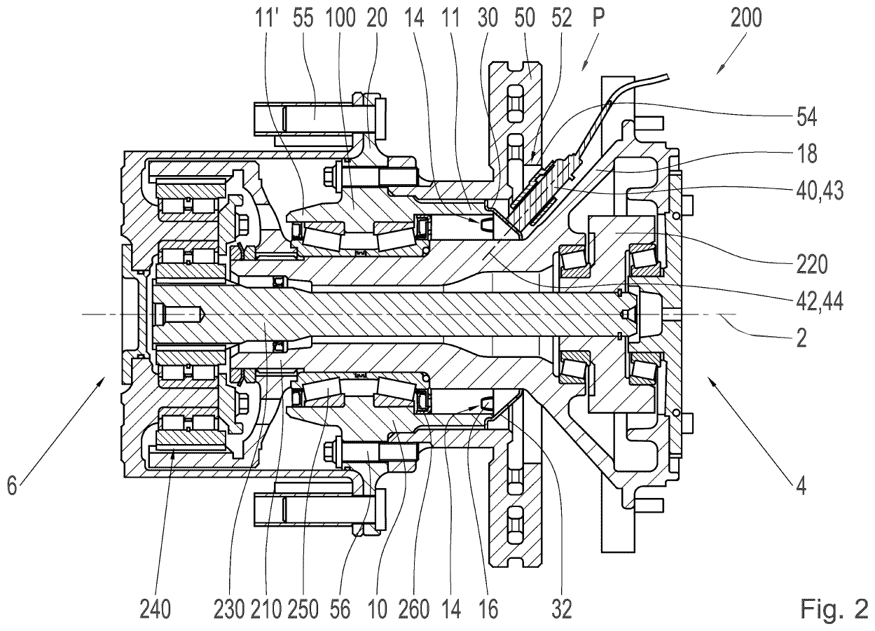

FIG. 2 shows a wheel head 200 in a sectional view through an axis of rotation 2 of a wheel hub 100, which the wheel head 200 has. The wheel head 200 has a hub carrier 210, which is designed as a stationary component of the wheel head 200. The wheel hub 100 is mounted on the hub carrier 210 via a wheel bearing 250 so that it can rotate about the axis of rotation 2. The wheel head 200 has a drive side 4 on which a drive device 220 is arranged for driving a drive shaft 230 of the wheel head 200. The hub base body 10 has a support section 18 for supporting the drive device 220, which extends radially to the axis of rotation 2. The wheel head 200 also has a wheel hub gear 240 for coupling the drive shaft 230 to the wheel hub 100.

The wheel hub 100 has a hub base body 10 and a wheel flange 20. The hub base body 10 extends axially to the axis of rotation 2 and is supported on the hub carrier 210 via the wheel bearing 250. The wheel flange 20 is arranged on the hub base body 10 and extends radially outward with respect to the axis of rotation 2. The wheel head 200 also has a brake disc 50, which is attached to the wheel flange 20 with brake disc bolts 56. Wheel bolts 55 are also arranged on the wheel flange 20, which are designed to securely fasten a wheel rim (not shown in the figures) to the wheel flange 20.

FIG. 2 further shows a sensor plate 30 in a pressed state P onto the hub base body 10. The wheel head 200 has the sensor plate 30 pressed onto the hub base body 10. In the pressed state P on the hub base body 10, a press fit connection is formed between the sensor plate 30 and the hub base body 10. The sensor plate 30 is pressed onto an axial end region 11 of the hub base body 10, which faces the drive side 4 of the wheel head 200. Support section 18 extends radially beyond sensor plate 30 with respect to the axis of rotation 2. The wheel hub gear 240 is arranged adjacent to the further axial end region 11′ of the hub base body 10, which is formed on a gear side 6 of the wheel head 200 opposite to the axial end region 11 of the hub base body 10 onto which the sensor plate 30 is pressed.

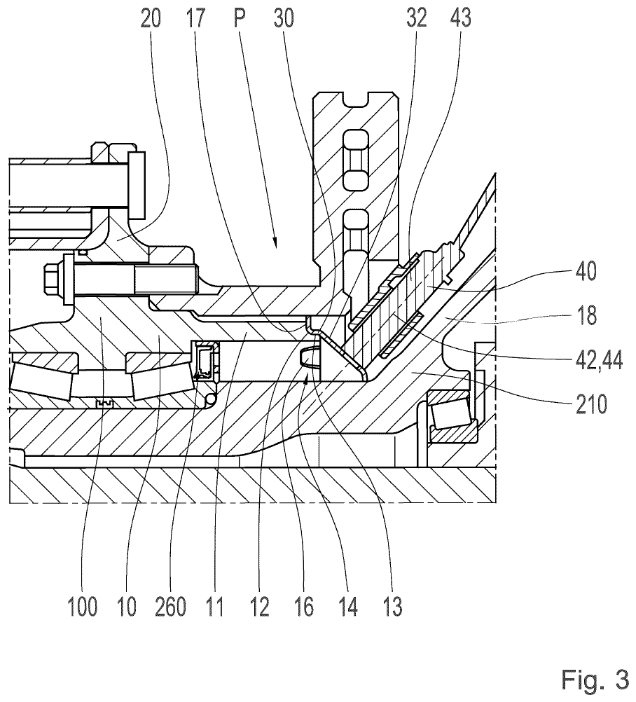

The wheel head 200 has a speed sensor 40 shown in FIGS. 2 and 3, which is arranged on the support section 18 of the hub carrier 210. The speed sensor 40 is arranged at an angle to the axis of rotation 2. The speed sensor 40 is designed to detect rotation of the wheel hub 100, which corresponds to rotation of the sensor plate 30, relative to the hub carrier 210. For this purpose, the sensor plate 30 has a detection ring 32 which extends conically or obliquely with respect to the axis of rotation 2. A detection region 42 of the speed sensor 40 is aligned with the conical detection ring 32 for detecting the rotation of the sensor plate 30. The detection region 42 is aligned at an angle to the axis of rotation 2 for this purpose. A longitudinal axis 44 of a sensor housing 43 of the speed sensor 40 also extends obliquely to the axis of rotation 2.

The wheel head 200 has a brake disc 60 which is attached to the wheel flange 20. The brake disc 50 has a circumferential radial offset 52, which forms an annular gap 54 between the brake disc 60 and the hub carrier 210. The speed sensor 40 is at least partially arranged in the annular gap 54.

FIG. 3 shows a detailed section of FIG. 3 in which the wheel hub 100 is shown with the hub base body 10 and the wheel flange 20, wherein a press fit contour 12 is formed on the hub base body 10 at the axial end region 11. In the pressed state P, the sensor plate 30 is pressed onto the press fit contour 12, which is formed on a radially outer region 13 of the hub base body 10. In the pressed state P. the sensor plate 30 strikes an axial stop 17 of the press fit contour 12, which is also formed on the radially outer region 13 of the hub base body 10.

The press fit contour 12 shown in FIGS. 2 and 3 has at least one contour interruption 14 extending axially to the axis of rotation 2. The contour interruption 14 extends beyond the press fit contour 12 into the hub base body 10, wherein, in the pressed state P of the sensor plate 30 pressed against the press fit contour 12, an opening 16 is formed in the hub base body 10 at the contour interruption 14. The opening 16 also forms an inlet and outlet for a mounting tool or dirty water into and out of a hub base body 10, a hub seal ring 260 arranged on the wheel bearing 250, the hub base body 10 of the wheel hub 100, and the pressed-on sensor plate 30.

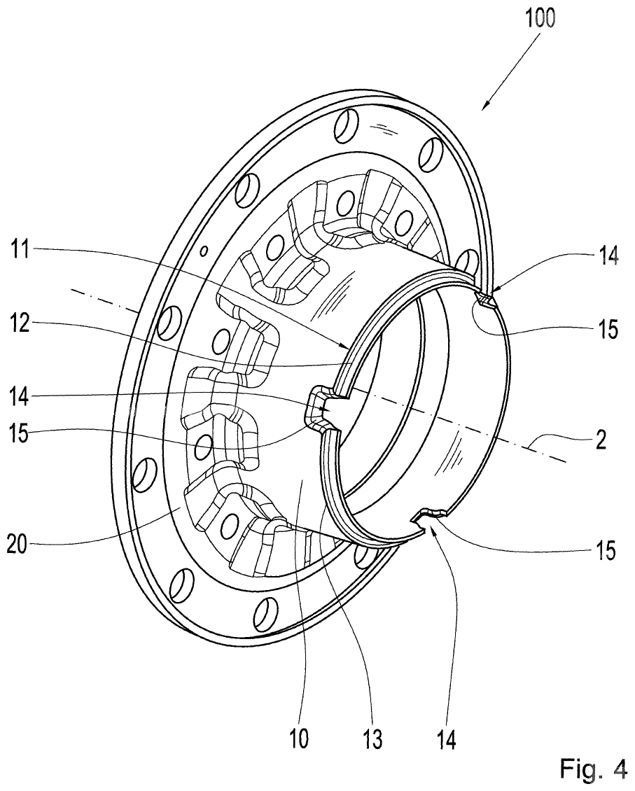

FIG. 4 shows the wheel hub 100 in an isolated view with the hub base body 10, the wheel flange 20, which is arranged on the hub base body 10 and extends radially to the axis of rotation 2. The hub base body 10 has the press fit contour 12 for forming the press fit connection of the sensor plate 30 with the hub base body 10. The press fit contour 12 in the embodiment shown in FIG. 4 has three contour interruptions 14. The contour interruptions 14 are formed on the press fit contour 12 with a uniform 120° angular offset relative to the axis of rotation 2. The press fit contour 12 is formed radially around the axial end region 11 of the hub base body 10. The press fit contour 12 is also formed on the radially outer region 13 of the hub base body 10. The contour interruptions 14 each form a recess 15 open on one side at the axial end region 11.

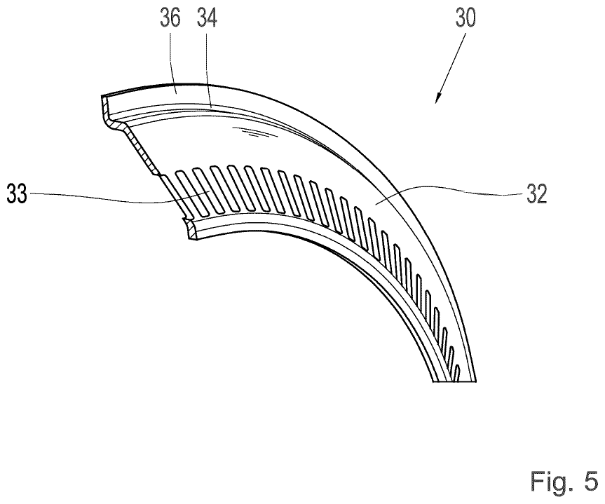

FIG. 5 shows the sensor plate 30 in an isolated view, in which the sensor plate 30 is shown in cross-section. The sensor plate 30 has a detection ring 32, which extends conically or is funnel-shaped. A plurality of detection recesses 33 are arranged in the detection ring 32, which trigger a speed signal when the detection ring 32 is scanned by the speed sensor 40. If speed sensor 40 is the ABS sensor, the speed signal is the ABS signal sampled by the ABS sensor. The sensor plate 30 has a press ring 34 that is continuous in the radial direction of rotation and is pressed onto the press fit contour 12 of the hub base body 10. The sensor plate 30 also has a chamfer 36, which is arranged on the press ring 34 and which, in the pressed state P of the sensor plate 30 pressed against the press fit contour 12, strikes against the axial stop 17 of the press fit contour 12.

### REFERENCE NUMBERS

2 axis of rotation
4 drive side
6 gear side
10 hub base body
11, 11′ axial end region
12 press fit contour
13 outer region
14 contour interruption
15 recess
16 opening
17 stop
18 support section
20 wheel flange
30 sensor plate
32 detection ring
33 detection recesses
34 press ring
36 chamfer
40 speed sensor
42 detection region
43 sensor housing
44 longitudinal axis
50 brake disc
52 radial offset
54 annular gap
55 wheel bolts
56 brake disc bolts
100 wheel hub
200 wheel head
210 hub carrier
220 drive device
230 drive shaft
240 wheel hub gear
250 wheel bearing
260 hub seal ring
300 motor vehicle
310 axis
320 energy source
P pressed state

1. A wheel hub (100) for a wheel head (200) of a motor vehicle (300), the wheel hub comprising:
a hub base body (10) extending axially to an axis of rotation (2) of the wheel bub (100); and
a wheel flange (20) arranged on the hub base body (10), wherein the wheel flange (20) extends radially to the axis of rotation (2); and
wherein the hub base body (10) has a press fit contour (12) configured for forming a press fit connection of a sensor plate (30) for a speed sensor (40) with the hob base body (10), and wherein the press fit contour (12) has at least one contour interruption (14).

2. The wheel hub (100) according to claim 1, wherein the press fit contour (12) is formed on a radially circumferentially on an axial end region (11) of the hub base body (10), and the at least one contour interruption (14) has a recess (15) open on one side.

3. The wheel hub (100) according to claim 1, wherein the press fit contour (12) is formed on a radially outer region (13) of the hob base body (10).

4. The wheel hub (100) according to claim 1, wherein the press fit contour (12) has at least two contour interruptions (14) which are formed on the press fit contour (12) with a uniform rotational angle offset relative to the axis of rotation (2).

5. The wheel hub (100) according to claim 1, wherein the at least one contour interruption (14) extends axially to the axis of rotation (2) and beyond the press fit contour (12) into the hub base body (10), wherein, in a pressed state (P) of the sensor plate (30) pressed against the press fit contour (12), an opening (16) is formed in the hub base body (10) at the contour interruption (14).

6. A wheel head (200) for an axle (310) of a motor vehicle (300), the wheel head comprising:
a hub carrier (210);
a wheel hub (100) mounted on the hub carrier (210) so as to be rotatable about an axis of rotation (2), wherein the wheel hub (100) has a hub base body (10) which extends axially to the axis of rotation (2);
a wheel flange (20) arranged on the hub base body (10);
a sensor plate (30) pressed onto the hub base body (10); and
a speed sensor (40) arranged on the hub carrier (210) and is configured to detect rotation of the sensor plate (30) relative to the hub carrier (210);
wherein the sensor plate (30) has a detection ring (32) which extends conically with respect to the axis of rotation (2), and a detection region (42) of the speed sensor (40) is aligned with the conical detection ring (32).

7. The wheel head (200) according to claim 6, wherein longitudinal axis (44) of a sensor housing (43) of the speed sensor (40) extends obliquely to the axis of rotation (2).

8. The wheel head (200) according to claim 6, wherein the wheel hub (100) is configured according to claim 1, and wherein the sensor plate (30) is pressed onto the press fit contour (12) having the at least one contour interruption (14).

9. The wheel head (200) according to claim 6, wherein the sensor plate (30) has a press ring (34) which is continuous in the radial circumferential direction and is pressed onto the hub base body (10).

10. The wheel head (200) according to claim 6, wherein the sensor plate (30) is pressed onto an axial end region (11) of the hub base body (10) which faces a drive side (4) of the wheel head (200), and a drive device (220) for driving a drive shaft (230) of the wheel head (200) is arranged on the drive side (4).

11. The wheel head (200) according to claim 10, wherein the hub base body (10) has a support section (18) for supporting the drive device (220), which extends radially to the axis of rotation (2), and the support section (18) extends radially beyond the sensor plate (30) with respect to the axis of rotation (2).

12. The wheel head (200) according to claim 10, comprising a wheel hub (240) for coupling the drive shaft (230) to the wheel hub (100), wherein wheel hub gear (240) is arranged adjacent to the further axial end region (11′) of the hub base body (10), which is opposite the axial end region (11) of the hub base body (10) onto which the sensor plate (30) is pressed, on a gear side (6) of the wheel head (200).

13. The wheel head (200) according to claim 6, comprising a brake disc (SO) fastened to the wheel flange (20), wherein brake disc (50) has a circumferential radial offset (52) which forms an annular gap (54) between the brake disc (50) and the hub carrier (210) and in which the speed sensor (40) is at least partially arranged.

14. An axle (310) of a motor vehicle (300), wherein the axle has the wheel head (200) according to claim 5.

15. A motor vehicle (300), comprising an axle and the wheel head (200) according to claim 5

16. The motor vehicle (300) according to claim 15, which is configured as a commercial vehicle and has an energy source (320) for electrically driving the axle (310).
